(19) United States
(12) Patent Application Publication
(10) Pub. No.: US 2009/0325474 A1
(43) Pub. Date: Dec. 31, 2009

(54) METHOD AND APPARATUS FOR PROCESSING SEA CUCUMBERS

(76) Inventor: Chester L. Batson, Jonesport, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 12/164,978

(22) Filed: Jun. 30, 2008

(51) Int. Cl. A22C 29/00

(52) U.S. Cl. 452/18; 452/19

(57) ABSTRACT

An improved method for processing sea cucumbers by applying pressure to the outer body of a decapitated sea cucumber, thereby forcing the layer of longitudinal muscle bands and internal viscera out of the outer body allowing for ready separation of the components for further processing, and an apparatus for implementing said improved method.

### BACKGROUND OF THE INVENTION

1. Technical Field

The invention relates generally to the field of marine aquaculture. More specifically, the invention is directed to an improved method and apparatus for processing sea cucumbers.

2. Description of Prior Art

Sea cucumbers are any of the more than one thousand species of marine invertebrates belonging to a group of echinoderms called holothurians. They have soft, cylindrical bodies, ranging in length from less than an inch to several feet, and in thickness from half an inch to almost a foot. They are usually a dull, dark color and their outer skin is often warty, thus resembling a cucumber. They are sluggish, bottom dwelling animals that are found worldwide. Sea cucumbers have a tough, leathery outer skin, a mouth located at one end having a circle of branching tentacles, and an anal opening at the other end. The internal organs (viscera) of the sea cucumber lay within the tube-like body chamber surrounded by the skin and a layer of longitudinal muscle bands.

There are several species of edible holothurians, including Cucumaria frondosa, which is found off the northeast coast of the United States. Sea cucumber meat, which includes the body wall and longitudinal muscle bands, is highly prized in many Asian markets. Sea cucumbers traditionally have been processed by cutting the outer skin with a knife and removing the longitudinal muscle bands by hand. This is a labor-intensive, time consuming method. Moreover, Cucumaria frondosa has a particularly tough outer skin, making it especially difficult to prepare.

Recently, there has been disclosed a method of improved sea cucumber processing utilizing a vacuum system for removing the viscera from a sea cucumber. However, this method still relies on an initial step of cutting open the sea cucumber by hand to expose the internal organs and fluids. It also does not separate the layer of longitudinal muscle bands from the outer skin. Moreover, it is complicated and costly and is not amenable to use by small sea cucumber processors. There is therefore a need for an improved method of separating the desirable portions of a sea cucumber during processing which is effective and simple to use while reducing the amount of labor needed to perform the task.

The present invention overcomes the problem of separating the components of a sea cucumber to more readily obtain the desired portions. As more fully described below, the disclosed methods and apparatus utilize the application of pressure to a sea cucumber to force apart the various components of a sea cucumber quickly and easily, greatly facilitating further processing.

It is therefore an objective of the present invention to provide one or more useful methods for separating the components of a sea cucumber.

It is a further objective of the present invention to provide one or more useful methods for separating the components of the species Cucumaria frondosa.

It is yet a further objective of the present invention to provide one or more useful methods for separating the components of a sea cucumber by the application of pressure thereto.

It is yet a further objective of the present invention to provide one or more useful methods for separating the components of a sea cucumber which are simple in application.

It is yet a further objective of the present invention to provide a useful apparatus for separating the components of a sea cucumber.

It is yet a further objective of the present invention to provide a useful apparatus for separating the components of the species Cucumaria frondosa.

It is yet a further objective of the present invention to provide a useful apparatus for separating the components of a sea cucumber by the application of pressure thereto.

It is yet a further objective of the present invention to provide a useful apparatus for separating the components of a sea cucumber which is simple in application.

Other objectives of the present invention will be readily apparent from the description that follows.

### SUMMARY OF THE INVENTION

The present invention discloses various methods for processing sea cucumbers and apparatuses for practicing those methods. The methods utilize an application of mechanical pressure to a decapitated sea cucumber. The pressure on the outer portions of the sea cucumber forces the layer of longitudinal muscle bands and the viscera out of the sea cucumber through the opening created by the removal of the anterior portion (“head”) of the sea cucumber.

The basic method involves the steps of obtaining a sea cucumber; removing a portion of the anterior end of the sea cucumber to expose the layer of longitudinal muscle bands and viscera; applying pressure to the sea cucumber such that the application of pressure squeezes the longitudinal muscle bands and viscera out of the sea cucumber through the first end; and separating the longitudinal muscle bands from the remainder of the sea cucumber. Variations of the basic method include using either a knife or other hand-held cutting implement to remove the anterior end of the sea cucumber or using an automated cutting device, such as a guillotine blade, a circular slicing blade, or the like. Other variations include using one or more cylindrical rollers to apply the pressure to the sea cucumber, or substantially planar pressing surfaces to apply the pressure to the sea cucumber, or a combination. Yet other variations employ conveyor belts to move the sea cucumbers into contact with the pressing mechanism.

The apparatuses disclosed by the present invention are suitable for implementing the above described methods. These apparatuses may use one or more cylindrical rollers, or substantially planar pressing surfaces, or a combination. The apparatuses may be hand powered, electrically powered, hydraulically powered, or some combination thereof. Variations may also employ conveyor belts to move the sea cucumbers into contact with the pressing mechanism.

Other features and advantages of the invention are described below.

### DESCRIPTION OF THE DRAWINGS

FIG. 1A is a perspective view of one embodiment of the device in which the method of applying pressure to the sea cucumber utilizes a cylindrical roller and a substantially planar pressing surface.

FIG. 1B is a plan view of the embodiment of the device and method depicted in FIG. 1A.

FIG. 2 is a perspective view of another embodiment of the device in which the method of applying pressure to the sea cucumber utilizes two cylindrical rollers.

FIG. 3 is a perspective view of yet another embodiment of the device in which the method of applying pressure to the sea cucumber utilizes two cylindrical rollers and a conveyor belt.

FIG. 4 is a plan view of yet another embodiment of the device in which the method of applying pressure to the sea cucumber utilizes multiple cylindrical rollers and the pressing surface is a conveyor belt.

FIG. 5 is a perspective view of an embodiment of the device in which the method of applying pressure to the sea cucumber utilizes two substantially parallel pressing surfaces.

FIG. 6 is a perspective view of an embodiment of the device in which the method of applying pressure to the sea cucumber utilizes two pressing surfaces at an angle to each other.

FIG. 7 is a perspective view of an alternative embodiment of the device in which the method of applying pressure to the sea cucumber utilizes two pressing surfaces at an angle to each other, whereby the two pressing surfaces are hingedly connected to each other.

### DETAILED DESCRIPTION OF THE INVENTION

The present invention discloses an improved method for processing a sea cucumber 10. The method is applicable to any of the edible species of sea cucumbers 10, but especially to the species Cucumaria frondosa. In all cases, the sea cucumber 10 to be processed is substantially elongate, has a first end 12 and a second end 14 located opposite the first end 12, and has an outer portion 16, a layer of longitudinal muscle bands 18, and internal viscera 19.

In the most general embodiment, the improved method comprises the steps of:

A: obtaining a sea cucumber 10;

B: removing a portion of the first end 12 of the sea cucumber 10, thereby creating an opening 13 and exposing the layer of longitudinal muscle bands 18 and viscera 19;

C: applying pressure to the sea cucumber 10 such that the application of pressure squeezes the longitudinal muscle bands 18 and viscera 19 out of the sea cucumber 10 through the opening 13 at the first end 12; and

D: separating the longitudinal muscle bands 18 from the outer portion 16 and viscera 19.

In one embodiment the removal of the portion of the first end 12 of the sea cucumber 10 to create an opening 13 in step B is performed by use of a knife. The knife may be held by a human hand in a manual operation. A circumferential cut is made about the first end 12 of the sea cucumber 10 through the outer portion 16. Alternatively, the knife may be used to make a through cut through the outer portion 16 of the sea cucumber 10 at the first end 12 generally perpendicular to the longitudinal axis of the sea cucumber 10. In other embodiments the knife may be attached to a mechanical device.

In yet other embodiments the removal of the portion of the first end 12 of the sea cucumber 10 is step B is performed by use of an automated cutting device. The automated device may incorporate a guillotine blade for decapitating the sea cucumber 10 to create an opening 13 at the first end 12. Alternately, a circular slicing blade may be used. Any other appropriate method for removing the first end 12 of the sea cucumber 10 known in the art, whether manual or by use of an automatic device, is also contemplated by this invention.

Step C of the method involves applying pressure to the sea cucumber 10 to force the longitudinal muscle bands 18 and viscera 19 out of the opening 13 at the first end 12. In the preferred embodiment the pressure is applied asymmetrically to the sea cucumber 10, first beginning at its second end 14 and thereafter in a continuous manner being applied substantially along the longitudinal axis of the sea cucumber 10 towards its first end 12. This action mimics, for example, the application of pressure to an open tube of tooth paste to cause the paste to be most efficiently squeezed therefrom. Alternatively, the pressure may be applied uniformly to the outer body 16 of the sea cucumber 10. Because the outer portion 16 of the body is entirely intact except for the opening 13 at the first end 12, the application of uniform pressure will tend to squeeze the longitudinal muscle bands 18 and viscera 19 out of the sea cucumber 10 through the opening 13 at the first end 12.

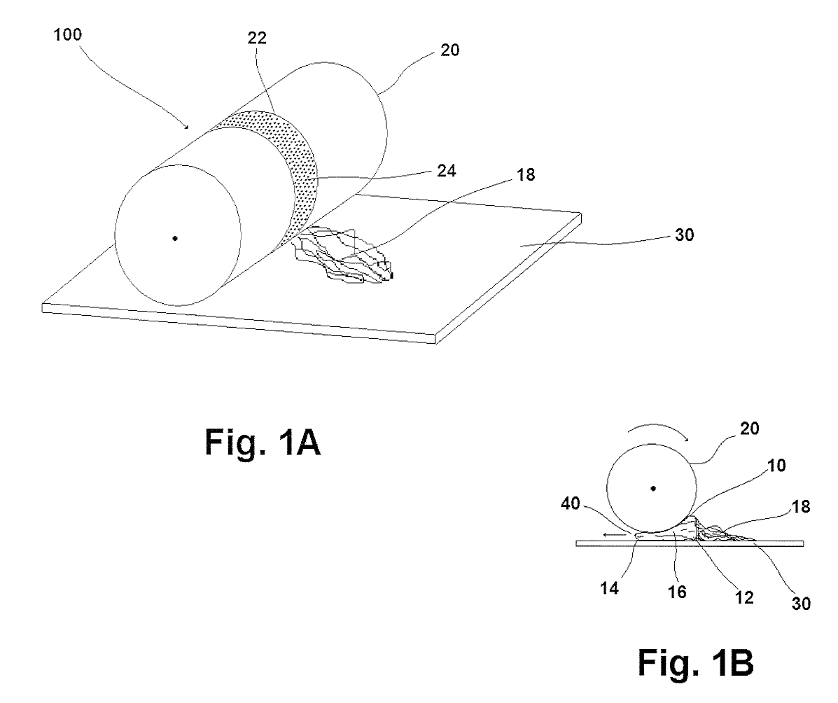

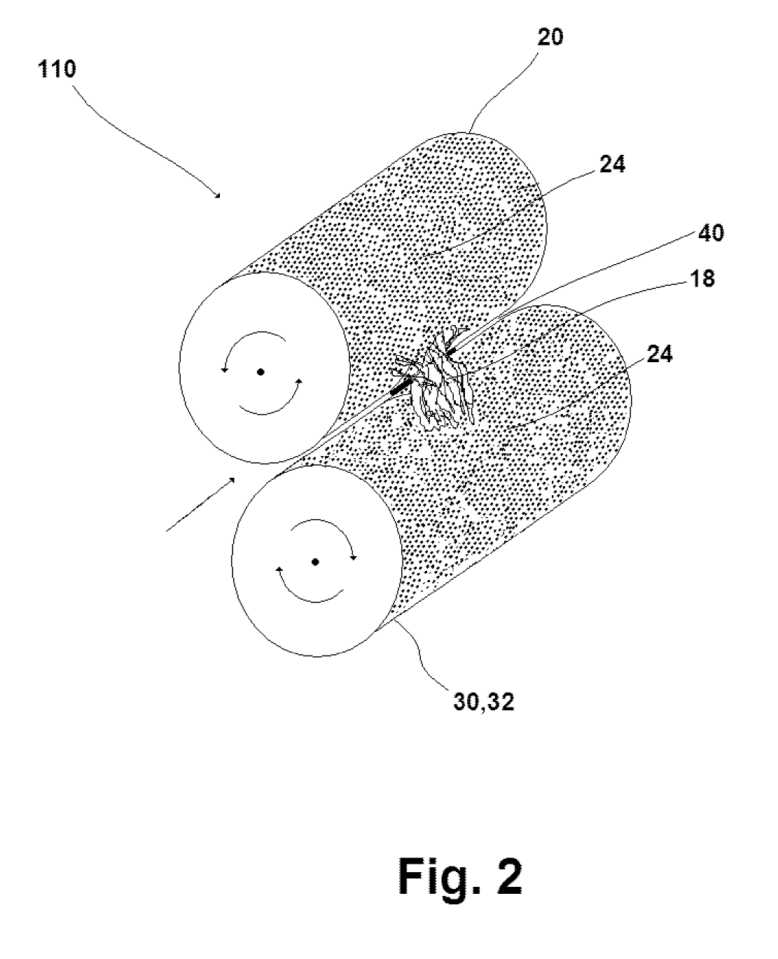

In one embodiment, the application of pressure to the sea cucumber 10 in step C of the method is accomplished by the use of a cylindrical roller 20 in near proximity to a substantially planar pressing surface 30. See FIG. 1. The cylindrical roller 20 is spaced apart from the pressing surface 30 forming a gap 40 that is somewhat smaller than the cross-section of the sea cucumber 10. Step C is performed by placing the second end 14 of the sea cucumber 10 into the gap 40 between the cylindrical roller 20 and the pressing surface 30, with the longitudinal axis of the sea cucumber 10 oriented substantially perpendicular to the longitudinal axis of the cylindrical roller 20. The sea cucumber 10 is then moved through the gap 40. The pressure exerted on the sea cucumber 10 by the cylindrical roller 20 and the pressing surface 30 squeezes the longitudinal muscle bands 18 and viscera 19 out of the sea cucumber 10.

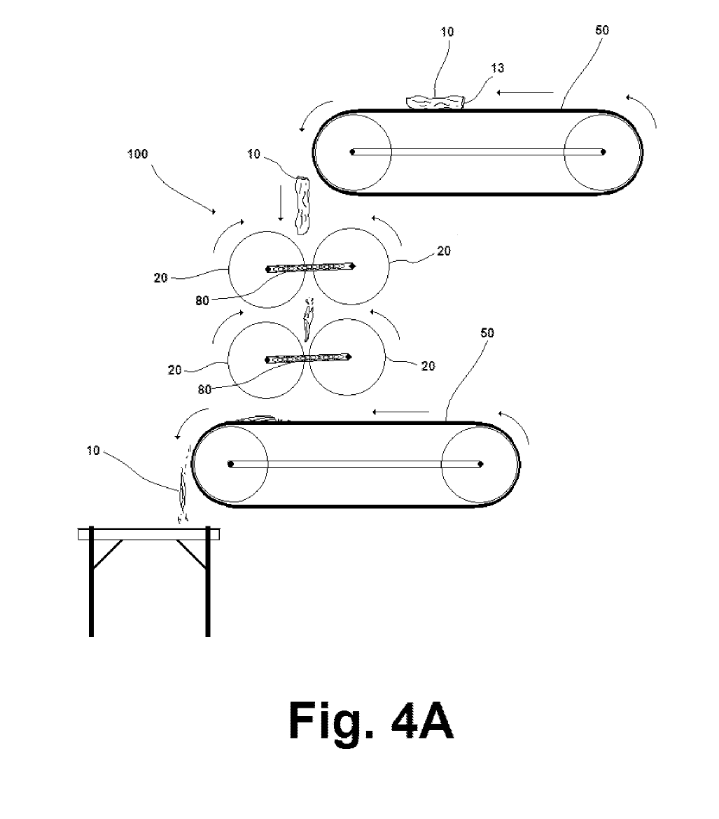

In another embodiment of the method, the application of pressure to the sea cucumber 10 in step C is accomplished by the use of a plurality of cylindrical rollers 20 in near proximity to a substantially planar pressing surface 30. See FIG. 4. Each of the cylindrical rollers 20 is oriented parallel to and in close proximity to the other cylindrical rollers 20. The plurality of cylindrical rollers 20 work in conjunction with the pressing surface 30 in the same manner as in the embodiment utilizing just one cylindrical roller 20, and the sea cucumber 10 is moved between the cylindrical rollers 20 and the pressing surface 30 in the same manner. In an alternative embodiment, each of the cylindrical rollers 20 forms a different sized gap 40 with the pressing surface 30, with the largest gap 40 being formed between the pressing surface 30 and the cylindrical roller 20 which first contacts the second end 14 of the sea cucumber 10, and the gaps 40 for each successive cylindrical roller 20 being slightly smaller, with the final cylindrical roller 20 forming the smallest gap 40 with the pressing surface 30. This configuration allows for pressure to be exerted in an ever increasing manner along the length of the sea cucumber 10, thereby more efficiently extracting the longitudinal muscle bands 18 and viscera 19 while minimizing the risk of rupturing the outer body 16.

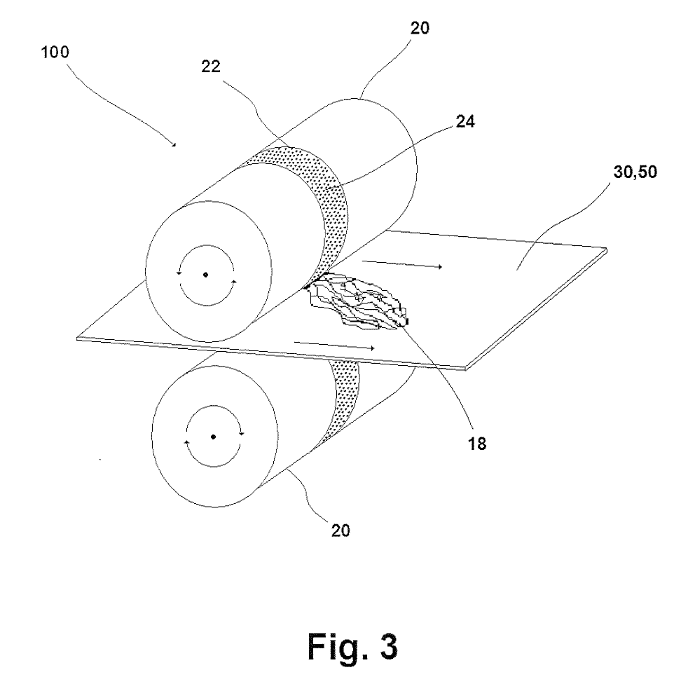

In yet another embodiment, the pressing surface 30 is a cylindrical roller 32 oriented substantially parallel to each of the other of the one or more cylindrical rollers 20. See FIG. 2.

In each embodiment of the method utilizing cylindrical rollers 20, an alternate configuration provides that at least one of the one or more cylindrical rollers 20 has a circumferential band 22 having gripping members 24. The gripping members 24 may be projections depending outward from the surface of the cylindrical roller 20, such as teeth or small flanges, or depressions formed into the surface of the cylindrical roller 20, or a combination of both, or simply a roughening of the surface. Ideally the circumferential band 22 is of substantially uniform width, though it need not be in all circumstances. The use of gripping members 24 improves movement of the sea cucumber 10 past the cylindrical roller 20, as fluids extracted from the sea cucumber 10 during the application of pressure thereto may otherwise reduce the friction between the cylindrical roller 20 and the sea cucumber 10.

In the embodiments utilizing one or more cylindrical rollers 20, the method may further comprise the steps of:

B1: causing the one or more cylindrical rollers 20 to rotate, with each such roller 20 rotating in the same direction as each other roller 20; and

B2: placing the second end 14 of the sea cucumber 10 into the gap 40 between one of the cylindrical rollers 20 and the pressing surface 30 such that said roller 20 and said pressing surface 30 simultaneously contact the second end 14 of the sea cucumber 10.

In these embodiments, step B1 is begun before step C and continues until step C is completed. Step B2 is performed after step B and before step C. Where the pressing surface 30 is also a cylindrical roller 32, step B1 is modified such that the pressing surface roller 32 rotates in a direction opposite the rotation of the other cylindrical rollers 20. The rotation of the one or more cylindrical rollers 20 in step B1 may be performed by use of a hand crank or other manual device. In the preferred embodiment the rotation is accomplished by use of one or more powered devices, such as an electric motor 70.

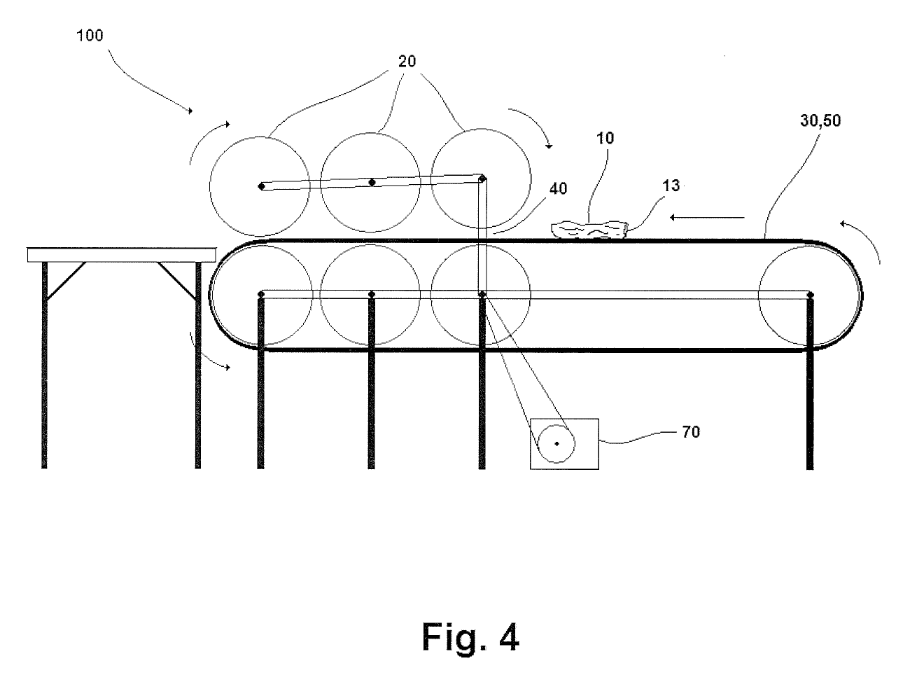

In an alternative embodiment of the method using one or more rotating cylindrical rollers 20, step B2 is performed by use of a conveyor belt 50. See FIGS. 3 and 4. The conveyor belt 50 may be located adjacent to the gap 40 between the cylindrical roller 20 and the pressing surface 30, such that a sea cucumber 10 placed on the conveyor belt 50 will be carried towards the gap 40. In such a configuration when the sea cucumber 10 is placed on the conveyor belt 50 its second end 14 is oriented towards the gap 40, and as the sea cucumber 10 reaches the end of the conveyor belt 50 its second end 14 extends beyond the end of the conveyor belt 50 and is placed into the gap 40. In the preferred embodiment the conveyor belt 50 runs between the one or more cylindrical rollers 20 and the pressing surface 30. In yet another embodiment the conveyor belt 50 itself serves as the pressing surface 30. In all embodiments using a conveyor belt 50 and one or more rotating cylindrical rollers 20 the sea cucumber 10 should be placed on the conveyor belt 50 with its second end 14 oriented towards the one or more cylindrical rollers 20. The conveyor belt 50 moreover may be a flexible, continuous belt that runs in a single direction, or a substantially rigid member which runs in two opposing directions.

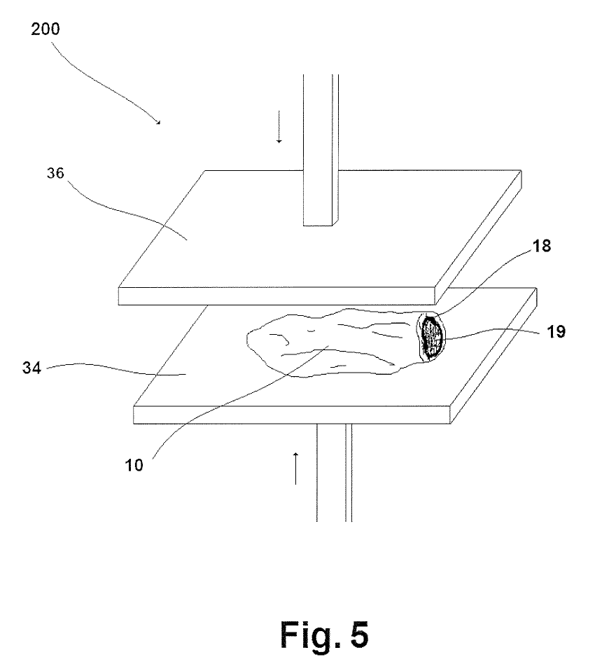

In yet another alternative embodiment of the method, the application of pressure to the sea cucumber 10 in step C is accomplished by the use of a first pressing surface 34 and a second pressing surface 36. See FIGS. 5-7. The first and second pressing surfaces 34,36 are substantially planar and are suitably adapted to move towards each other and away from each other. In one embodiment step C comprises the substeps of:

C1: placing the sea cucumber 10 onto the first pressing surface 34 between the first and second pressing surfaces 34,36; and

C2: moving the first and second pressing surfaces 34,36 towards each other such that the first and second pressing surfaces 34,36 simultaneously contact the sea cucumber 10.

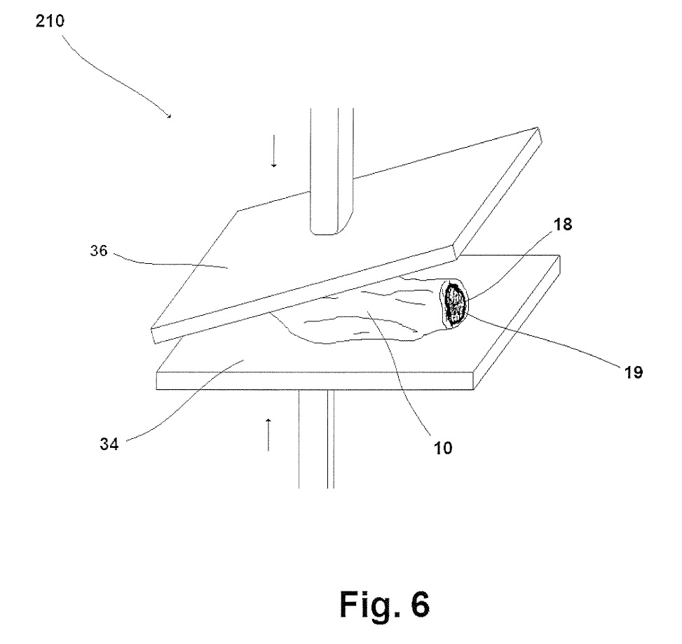

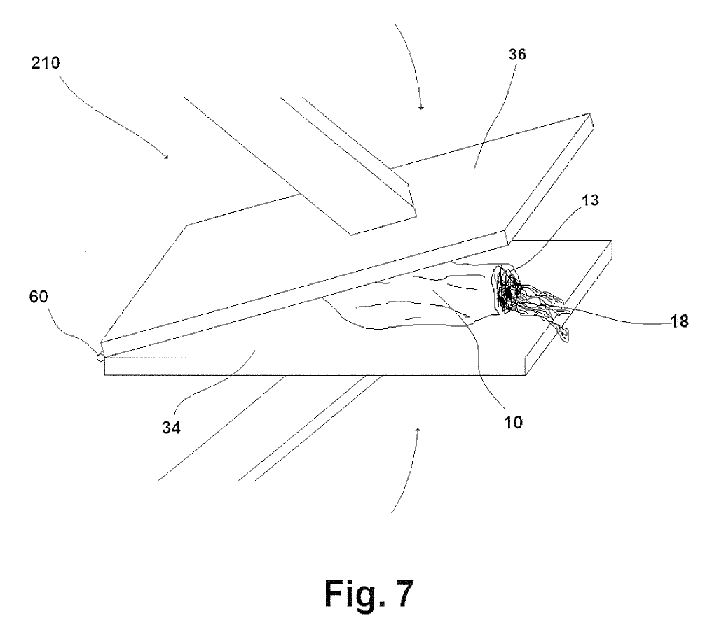

In one alternative of this embodiment the first and second pressing surfaces 34,36 are substantially parallel to each other. See FIG. 5. In another alternative the first pressing surface 34 is oriented substantially horizontal and the second pressing surface 36 is located above the first pressing surface 34 at an angle to the first pressing surface 34. See FIG. 6. In this embodiment the sea cucumber 10 is placed onto the first pressing surface 34 in substep C1 whereby the sea cucumber 10 is oriented with its first end 12 towards the greater separation between the first and second pressing surfaces 34,36 and its second end 14 towards the lesser separation between the first and second pressing surfaces 34,36. Thus, in substep C2, when the first and second pressing surfaces 34,36 move towards each other the first and second pressing surfaces 34,36 simultaneously contact the sea cucumber 10 beginning at its second end 14. In this embodiment the first and second pressing surfaces 34,36 may be connected to each other by a hinge 60. See FIG. 7. In all embodiments using first and second pressing surfaces 34,36 hydraulics may be used to move the first and second pressing surfaces 34,36 toward and away from each other. Other methods of moving the pressing surfaces 34,36 are also contemplated by the present invention.

The present invention also discloses devices for accomplishing the method of the present invention. In one embodiment the device 100 comprises a cylindrical roller 20 in near proximity to a pressing surface 30, with the pressing surface 30 being substantially planar, and with the cylindrical roller 20 forming a gap 40 between it and the pressing surface 30, and with 12 the gap 40 being smaller than the cross-section of the sea cucumber 10, as described above. See FIG. 1. The device 100 is suitably adapted to apply pressure to a decapitated sea cucumber 10 when the second end 14 of the sea cucumber 10 is placed into the gap 40 between the cylindrical roller 20 and the pressing surface 30 and the cylindrical roller 20 is rotated such that the sea cucumber 10 is drawn between the cylindrical roller 20 and the pressing surface 30. As such, the pressure applied to the sea cucumber 10 begins at the second end 14 of the sea cucumber 10 and thereafter in a continuous manner progresses substantially along the longitudinal axis of the sea cucumber 10 towards its first end 12, squeezing the longitudinal muscle bands t8 and viscera 19 out of the sea cucumber 10 through the opening 13 at the first end 12. As described above, the pressing surface 30 may also be a cylindrical roller 32 oriented substantially parallel to the rotating cylindrical roller 20. See FIG. 2.

In another embodiment the device 100 may comprise a plurality of cylindrical rollers 20 located in near proximity to a substantially planar pressing surface 30. See FIG. 4. Each of the cylindrical rollers 20 is oriented parallel to and in close proximity to the other cylindrical rollers 20. The plurality of cylindrical rollers 20 work in conjunction with the pressing surface 30 as described above. In an alternative embodiment, each of the cylindrical rollers 20 forms a different sized gap 40 with the pressing surface 30, as described above. See FIG. 4.

In each embodiment utilizing cylindrical rollers 20, an alternate configuration provides that at least one of the one or more cylindrical rollers 20 has a circumferential band 22 having gripping members 24, as described above.

In the embodiments of the device 100,110 utilizing one or more cylindrical rollers 20, the cylindrical rollers 20 may be powered to rotate in the same direction. Power may t3 be provided by one or more electric motors 70. Alternatively, the one or more cylindrical rollers 20 may be rotated by hand, as by a crank. Where the pressing surface 30 is also a cylindrical roller 32, it will be rotated in the opposite direction as the other rollers 20.

In an alternative embodiment, the cylindrical roller 20 may be moved across the pressing surface 30 by a movable armature. In this embodiment the roller 20 is adapted to move in opposite directions, first rolling over the sea cucumber 10 to apply pressure and then rolling back, readying itself for the next sea cucumber 10.

In a preferred embodiment of the device 100, the pressing surface 30 is a conveyor belt 50. See FIGS. 3 and 4. In an alternative embodiment, the device 100 may utilize a conveyor belt 50 in conjunction with the one or more cylindrical rollers 20 and the pressing surface 30. In such a configuration the conveyor belt 50 is suitably adapted to place the second end 14 of the sea cucumber 10 into the gap 40 between one of the cylindrical rollers 20 and the pressing surface 30 such that said roller 20 and said pressing surface 30 simultaneously contact the second end 14 of the sea cucumber 10. As described above, the conveyor belt 50 may be a flexible, continuous belt that runs in a single direction, or a substantially rigid member which runs in two opposing directions. In the latter embodiment, the conveyor belt 50 first moves in a direction towards the one or more cylindrical rollers 20, and after pressure is applied to the sea cucumber 10 the conveyor belt 50 moves away from the one or more cylindrical rollers 20.

In another embodiment the device 200,210 comprises a first pressing surface 34 and a second pressing surface 36. See FIGS. 5-7. The first and second pressing surfaces 34,36 are substantially planar, the first pressing surface 34 is oriented substantially horizontal, and the second pressing surface 36 is located above the first pressing surface 34. The first and second t4 pressing surfaces 34,36 are further suitably adapted to move towards each other and away from each other. This may be accomplished by hydraulics, or any other method known in the art.

In this embodiment a decapitated sea cucumber 10 is placed onto the first pressing surface 34 between the first and second pressing surfaces 34,36, and the first and second pressing surfaces 34,36 are moved towards each other, causing the first and second pressing surfaces 34,36 to simultaneously contact the sea cucumber 10. This application of pressure squeezes the muscles bands 18 and viscera 19 of the sea cucumber 10 out through the opening 13 at the first end 12.

In one embodiment of the device 200 the second pressing surface 36 is oriented substantially parallel to the first pressing surface 34. See FIG. 5. In this embodiment pressure is applied substantially uniformly to all portions of the sea cucumber 10 simultaneously. In an alternative embodiment of the device 210 the second pressing surface 36 is oriented at an angle to the first pressing surface 34. See FIG. 6. In this embodiment the sea cucumber 10 is placed onto the first pressing surface 34 between the first and second pressing surfaces 34,36 oriented with its first end 12 towards the greater separation between the first and second pressing surfaces 34,36 and its second end 14 oriented towards the lesser separation between the first and second pressing surfaces 34,36. When the first and second pressing surfaces 34,36 are moved towards each other the first and second pressing surfaces 34,36 simultaneously contact the sea cucumber JO beginning at its second end 14, with the pressure applied to the sea cucumber 10 beginning first at its second end 14 and thereafter in a continuous manner substantially along its longitudinal axis towards its first end 12, squeezing the longitudinal muscle bands 18 and viscera 19 of the sea cucumber 10 through the opening 13 at the first end 12. In yet another embodiment, the first pressing surface 34 may be hingedly connected to the second pressing surface 36. See FIG. 7.

In all embodiments of the device 200,210 utilizing first and second pressing surfaces 34,36, the sea cucumbers 10 may be delivered to the first pressing surface 34 by a conveyor belt 50. Alternatively they may be placed thereupon by hand.

Those skilled in the art will perceive improvements, changes and modifications in the invention. Such improvements, changes and modifications within the skill of the art are intended to be covered by the claims set forth herein, and that all matter contained in the accompanying specification shall be interpreted as illustrative only and not in a limiting sense.

1. A method for processing a sea cumber, wherein the sea cucumber is substantially elongate, with a first end and a second end located opposite the first end and having an outer portion, a layer of longitudinal muscle bands, and internal viscera, said method comprising the steps of:
A: obtaining a sea cucumber;
B: removing a portion of the first end of the sea cucumber, thereby creating an opening and exposing the layer of longitudinal muscle bands and the viscera;
C: applying pressure to the sea cucumber such that the application of pressure squeezes the longitudinal muscle bands out of the sea cucumber through the opening at the first end; and
D: separating the longitudinal muscle bands from the outer portion and viscera.

2. The method of claim 1 wherein the sea cucumber obtained in step A is of the species Cucumaria frondosa.

3. The method of claim 1 wherein the removal of a portion of the first end of the sea cucumber in step B is performed by use of a knife.

4. The method of claim 1 wherein the removal of a portion of the first end of the sea cucumber in step B is performed by use of an automated cutting device.

5. The method of claim 1 wherein step C comprises applying pressure to the sea cucumber beginning at its second end and thereafter in a continuous manner substantially along a longitudinal axis of the sea cucumber towards its first end, such that the application of pressure squeezes the longitudinal muscle bands out of the sea cucumber through the first end.

6. The method of claim 5 wherein the application of pressure to the sea cucumber in step C is accomplished by the use of one or more cylindrical rollers in near proximity to a pressing surface, with each of the one or more cylindrical rollers forming a gap between said cylindrical roller and the pressing surface, each said gap being smaller than a cross-section of the sea cucumber;
whereby in applying pressure to the sea cucumber in step C the longitudinal axis of the sea cucumber is oriented substantially perpendicular to a longitudinal axis of each said cylindrical roller.

7. The method of claim 6 wherein the pressing surface is substantially planar.

8. The method of claim 6 wherein the pressing surface is a cylindrical roller oriented substantially parallel to each of the other of the one or more cylindrical rollers.

9. The method of claim 6 wherein at least one of the one or more cylindrical rollers comprises a circumferential band having gripping members.

10. The method of claim 6 further comprising the steps of:
B1: causing the one or more cylindrical rollers to rotate, each such roller rotating in the same direction; and
B2: placing the second end of the sea cucumber into the gap between one of the cylindrical rollers and the pressing surface such that said roller and said pressing surface simultaneously contact the second end of the sea cucumber;
wherein step B1 is begun before step C and continues until step C is completed, and step B2 is performed after step B and before step C.

11. The method of claim 10 wherein step B2 is performed by use of a conveyor belt.

12. The method of claim 11 wherein the conveyor belt runs between the one or more cylindrical rollers and the pressing surface.

13. The method of claim 11 wherein the conveyor belt is the pressing surface.

14. The method of claim 1 wherein the application of pressure to the sea cucumber in step C is accomplished by the use of a first pressing surface and a second pressing surface, wherein the first and second pressing surfaces are substantially planar, with the first pressing surface oriented substantially horizontal and the second pressing surface oriented substantially parallel to and located above the first pressing surface, with the first and second pressing surfaces suitably adapted to move towards each other and away from each other, with step C comprising the substeps of:
C1: placing the sea cucumber onto the first pressing surface between the first and second pressing surfaces; and
C2: moving the first and second pressing surfaces towards each other such that the first and second pressing surfaces simultaneously contact the sea cucumber.

15. The method of claim 5 wherein the application of pressure to the sea cucumber in step C is accomplished by the use of a first pressing surface and a second pressing surface, with the first and second pressing surfaces being substantially planar, with the first pressing surface oriented substantially horizontal and the second pressing surface located above the first pressing surface at an angle to the first pressing surface, with the first and second pressing surfaces suitably adapted to move towards each other and away from each other, with step C comprising the substeps of:
C1: placing the sea cucumber onto the first pressing surface between the first and second pressing surfaces, with the sea cucumber oriented with its first end towards a greater separation between the first and second pressing surfaces and its second end towards a lesser separation between the first and second pressing surfaces; and
C2: moving the first and second pressing surfaces towards each other such that the first and second pressing surfaces simultaneously contact the sea cucumber, beginning at its second end.

16. A device for processing a sea cucumber, wherein the sea cucumber is substantially elongate, with a first end and a second end located opposite the first end and having an outer portion, a layer of longitudinal muscle bands, and internal viscera, said sea cucumber having a portion of its first end removed, thereby exposing the longitudinal muscle bands and viscera,
said device comprising one or more cylindrical rollers in near proximity to a pressing surface, with each of the one or more cylindrical rollers forming a gap between said cylindrical roller and the pressing surface, each said gap being smaller than a cross-section of the sea cucumber,
whereby said device is suitably adapted to apply pressure to the sea cucumber when the second end of the sea cucumber is placed into the gap between one of the one or more cylindrical rollers and the pressing surface and the one or more cylindrical rollers are rotated such that the sea cucumber is drawn between the one or more cylindrical rollers and the pressing surface, with said pressure applied to the sea cucumber beginning at the second end of the sea cucumber and thereafter in a continuous manner substantially along a longitudinal axis of the sea cucumber towards its first end, such that the application of pressure squeezes the longitudinal muscle bands out of the sea cucumber through the first end.

17. The device of claim 16 wherein the pressing surface is substantially planar.

18. The device of claim 16 wherein the pressing surface is a cylindrical roller oriented substantially parallel to each of the other of the one or more cylindrical rollers.

19. The device of claim 16 wherein at least one of the one or more cylindrical rollers comprises a circumferential band having gripping members.

20. The device of claim 16 wherein the pressing surface is a conveyor belt.

21. The device of claim 16 further comprising a conveyor belt;
whereby the conveyor belt is suitably adapted to place the second end of the sea cucumber into the gap between one of the cylindrical rollers and the pressing surface such that said roller and said pressing surface simultaneously contact the second end of the sea cucumber.

22. A device for processing a sea cucumber, wherein the sea cucumber is substantially elongate, with a first end and a second end located opposite the first end and having an outer portion, a layer of longitudinal muscle bands, and internal viscera, said sea cucumber having a portion of its first end removed, thereby exposing the longitudinal muscle bands and viscera,
said device comprising a first pressing surface and a second pressing surface, wherein the first and second pressing surfaces are substantially planar, the first pressing surface is oriented substantially horizontal and the second pressing surface is located above the first pressing surface, with the first and second pressing surfaces suitably adapted to move towards each other and away from each other;
whereby said device is suitably adapted to apply pressure to the sea cucumber when the sea cucumber is placed onto the first pressing surface between the first and second pressing surfaces, and the first and second pressing surfaces are moved towards each other such that the first and second pressing surfaces simultaneously contact the sea cucumber, with said pressure applied to the sea cucumber such that the application of pressure squeezes the longitudinal muscle bands of the sea cucumber through the first end.

23. The device of claim 22 wherein the second pressing surface is oriented substantially parallel to the first pressing surface.

24. The device of claim 22 wherein the second pressing surface is oriented at an angle to the first pressing surface;
whereby said device is suitably adapted to apply pressure to the sea cucumber when the sea cucumber is placed onto the first pressing surface between the first and second pressing surfaces, with the sea cucumber oriented with its first end towards a greater separation between the first and second pressing surfaces and its second end towards a lesser separation between the first and second pressing surfaces, and the first and second pressing surfaces are moved towards each other such that the first and second pressing surfaces simultaneously contact the sea cucumber, beginning at its second end, with said pressure applied to the sea cucumber beginning at the second end of the sea cucumber and thereafter in a continuous manner substantially along a longitudinal axis of the sea cucumber towards its first end, such that the application of pressure squeezes the longitudinal muscle bands of the sea cucumber through the first end.

25. The device of claim 24 wherein the first pressing surface is hingedly connected to the second pressing surface.

26. The method of claim 8 further comprising the steps of:
B1: causing the one or more cylindrical rollers to rotate; and
B2: placing the second end of the sea cucumber into the gap between one of the cylindrical rollers and the cylindrical roller comprising the pressing surface such that said pair of rollers simultaneously contact the second end of the sea cucumber;
wherein step B1 is begun before step C and continues until step C is completed, and step B2 is performed after step B and before step C.

27. The method of claim 26 wherein step B2 is performed by use of a conveyor belt and the conveyor belt runs above the one or more cylindrical rollers and drops the sea cucumber into the gap between said rollers.
